(19) United States
(12) Patent Application Publication
(10) Pub. No.: US 2016/0166466 A1
(43) Pub. Date: Jun. 16, 2016

(54) Massaging device (variants)

(71) Applicant: Sergei TOPOLEV, St. Petersburg (RU)

(72) Inventor: Sergei E. Topolev, St. Petersburg (RU)

(21) Appl. No.: 14/909,462

(22) PCT Filed: Jul. 15, 2014
(86) PCT No.: PCT/RU2014/000517

§ 371 Date: Feb. 1, 2016

(30) Foreign Application Priority Data
Jul. 30, 2013 (RU) 2013 135958

(51) Int. Cl. A61H 19/00; A61H 23/02

(52) U.S. Cl. CPC A61H 19/44; A61H 23/0263

(57) ABSTRACT

A massaging device for sexual stimulation comprises at least two elongated stimulation members (SM). Their first ends are connected, their second ends are free, spaced apart from each other and are adapted to be resiliently brought together. At least one SM is configured with a curvature towards the other. The SM can be configured to have a limited lateral displacement when brought together, can be locked to one another and unlocked once the device is inserted, and can be configured to be capable of longitudinal displacement against each other. Also, the first SM can be shorter than the second, the second having a recess for receiving the free end of the first one and being adapted to limit the lateral displacement of the SM when they are brought together. The free end of the second SM can also be made with a reverse curvature to lock the first SM.

### TECHNICAL FIELD

This invention relates to medical equipment, sexuality section, and in particular, to devices for personal use, intensifying arousal and facilitating the achievement of orgasm.

### PRIOR ART

It is known that for comfortable insertion of stimulating device into a vagina or anus its tip should preferably have a head rounded or round-conical shape enabling to guide vertex and pre-extending an opening, and a sliding surface of the head should preferably be smooth, without protrusions with negative angles, and stepped transitions. There is a known device “Stimulator with adjustable shape (variant embodiments)”, application for the invention RU2009131084, and “Stimulator with flexible members (variant embodiments)”, application for the invention RU2009145050. The described device is a dildo, in which a part intended for insertion into a vagina longitudinally divided into elongated stimulating members with separated apart free ends, which when approaching each other form a shape essentially a dildo, suitable for stimulation of the vagina, and inside the cavity they unbend apart from each other increasing the volume of the cavity and the area of stimulation, and for that purpose they are made flexible and resilient from elastically deformable material. Additionally, the device may be provided with locking device contiguous stimulating members. The disadvantage of this device is the difficulty of insertion the stimulating contiguous members. First, for easy insertion of the device, the approach of stimulating members necessary to keep a distance of about 2 cm or more from the ends, and the ends form a shape with two separated vertexes, which hampers their insertion, since one end is inserted freely, and the second end stops the vertex in the zone near the opening of the vagina or anus. Second, inserting of the ends of stimulating members may be displaced laterally in closing plane relative to each other, which also makes it difficult to use the device. Third, the described locking member in the form of a locking profile, located the first part on the inner surface of the stimulating member facing towards the other stimulating member and with its second mate part on the inner surface of the other stimulating member, is incapable to release fixed stimulating members in the inserting position. Their grip is provided by opposite clicking on the opposed surfaces of stimulating members, and does not allow disengaging them after insertion inside the cavity, as the described lock in the form of an electromagnetic device requires integration with additional technically complex members, as well as their power supply.

### SUMMARY OF THE INVENTION

The task of the claimed invention is to improve the device operation by increasing comfort of use when insertion approaching stimulating members.

An essential feature of the first embodiment is implementation with a bend and/or longer relative to the other, at least one of the elongate stimulating members connected or resiliently connected with their first ends and with separated apart free ends adapted to their resiliently approach, which are comprised in the device for sexual stimulation. Thus stimulating members can resiliently approach each other and give the device a form suitable for vaginal or anal stimulation so that approximation of free ends of the stimulating members form a shape substantially close to a dildo, and for that purpose they are wholly or partly made from an elastically deformable material, or are matched by means of a spring-loaded mechanical joint. Said bend is made towards the other stimulating member, and if there are more than two stimulating members, in the direction defined as a midpoint between the other extreme stimulating members and ensures maximum convergence of the vertex of the free end with the vertex of the other or vertex of each of the free ends so that their directions are substantially parallel to or intersect, especially if all the stimulating members are made with the same bend. The direction of the free end is defined as an imaginary straight line passing through preferential points of longitudinal axis of the free end and its vertex. The vertex of the free end is defined as the extreme point of the longitudinal axis on the stimulating member surface from the other end, or as the most sharpened place of the head. The presence of this bend if the case of the device is made from a resiliently deformable material, such as for example silicone rubber, should be provided to form of the approaches ends optimum shape for insertion, as when the stimulating members are bent or approached is uneven deformation of the outer and inner surfaces, facing the another or other surfaces of stimulating members. In this case the internal surface is compressed and the outer surfaces stretches, resulting in curvature of the stimulating member in the opposite direction to the direction of application of force its bending and convergence with another one or several other stimulating members. Said bend compensates for deformation, in particular if it is made displaced towards its free end, and especially if the stimulating members are made with a bend away from each other. Said elongation of one of the stimulating members with regard to the another or other stimulating members is adapted in such a way as to cover the top of vertex of another or other stimulating members when they approach each other so that their directions intersect this elongation. This implementation of the device allows the user to keep the connivent stimulating members at short distance, rather than at the very ends, when inserted, as well as, in the case of implementation with the elongation, first inserted the vertex of the elongated end and, pressing the other end, the vertex of which is hidden behind the elongation, easy insert the other stimulating member. The technical result of the first embodiment is to maximum convergence vertices of the free ends of stimulating members so as to form essentially one vertex significant for insertion or use only one vertex of the one elongated stimulating member that covers the vertex another or vertices other stimulating members and prevents their contact with the body by the insertion to the rapprochement position, that provides a comfortable insertion of the device.

An essential feature of the second embodiment is modification of the device for sexual stimulation, comprising at least two elongated stimulating members are connected with each other by their first ends, wherein free ends of these members adapted to their resiliently approach, thereby imparting the device essentially form a dildo suitable such as for vaginal and such as anal stimulation, adapted with restriction of lateral displacement of approached stimulating members, and/or their possibility of fixing each other in a approached position and their possibility of disengaging after insertion of the device. For that, for example, one stimulating member comprises a protrusion and the another or other stimulating members comprise a mating shape, into which put the protrusion when they approach. In the case of implementation the device with three stimulating members comprising with protrusions facing towards the middle of the distance between two other stimulating members, as they approach, the mating recess for protrusion is formed by adjacent lateral surfaces of protrusions of the other two approach stimulating members. For fixing the stimulating members in the approach position one or all stimulating members comprise a locking element, for example, a hook-shaped hatch on one stimulating member, which interacts with a mating shape on the other stimulating member or a free end of the other stimulating member, and wherein they are adapted longitudinal displacement with relative to each other, and for that purpose they are comprise a mechanism for providing said function, or made from an resiliently deformable material providing said displacement when they are bent towards one or other stimulating members in approaches position. Said longitudinal shift can be provided to the device manually after insertion of the device into the cavity. Preferably, implementation the device with at least one stimulating member adapted to bend towards the another or other stimulating members, preferably displace towards the free end. The technical result of the second embodiment is to restriction of the lateral displacement of the stimulating members ends, as well as fixing them to each other, the approach of stimulating members to form a shape suitable for insertion, to provide comfortable introduction of the device.

An essential feature of the third embodiment is execution of the device for sexual stimulation, comprising the first and at least the second elongated stimulating members connected to each other with their first ends, wherein the free ends of these members adapted to their resilient approach and thereby imparting device forms essentially a dildo suitable for vaginal and/or for anal stimulation, with lengthening relative to said, at least the second stimulating member, and presence of a groove on the surface of the first stimulating member facing toward the said at least the second stimulating element purposed to put a free end of the said, at least the second stimulating member, when they approach each other, and being essentially its mating shape. This groove serves as a restriction of lateral displacement and cover the vertex of the free end of the said, at least the second stimulating member, placed in it, when they approach. Besides, said groove can be provided with a function of fixing approached stimulating members, and for that purpose the front wall of the stimulating member formed by such groove is made with a reverse bend so that when a free end of the said, at least the second stimulating member is placed in it and the device is made with possibility longitudinal displacement of the stimulating members relative to each other, the front wall is resiliently fixes the free end positioned in the groove, and it is disengaged by the reverse longitudinal displacement of the stimulating members provided for the device once it is inserted into the cavity. Said longitudinal displacement is provide, for example, implementation the device or stimulating members from an resiliently deformable material and is provides by bending the approached stimulating members towards engaging or engaged stimulating member. Preferably to provide the device with at least one stimulating member with a bend towards the another or other several stimulating elements, preferably displaced towards the free end. The device may be made of an elastically deformable material such as silicone rubber, and also comprise a rigid housing or inner rigid frame, in particular, with moving parts. Additionally, the device may comprise a vibration device, comprising electromechanical unbalance rotation device, control system, in particular with remote control function, and a power supply unit, for example, with a rechargeable battery, in particular with contactless charging function, and also may be made with surface stimulating elements made as volumetric simple, fantasy or anatomical shapes and/or additional stimulating elements to stimulate the external genital organs. The technical result of the third embodiment is to restriction of the lateral displacement of the approaching stimulating members ends, use to insert approaching stimulating members of the vertex of one lengthening stimulating member, as well as their fixation with each other, when it is approached to form a shape convenient for insertion that provides a comfortable insertion of the device.

### BRIEF DESCRIPTION OF THE DRAWINGS

The invention is further described by preferred embodiments with reference to the accompanying drawings, in which:

FIG. 1 shows a side view of the first device modification according to the first embodiment of the invention in the static position;

FIG. 2—a side view of the device in FIG. 1 with the approach of stimulating members (hereinafter—SM);

FIG. 3—a side view of the second device modification according to the first embodiment of the invention in the static position;

FIG. 4—a side view of the device in FIG. 3 with the approach of SM;

FIG. 5—a side view of the third device modification according to the first embodiment of the invention in the static position;

FIG. 6—a side view of the device in FIG. 5 with the approach of SM;

FIG. 7—a side view of the first device modification according to the second embodiment of the invention in the static position;

FIG. 8—a side view of the device in FIG. 7 with the approach of SM;

FIG. 9—a side view of the second device modification according to the second embodiment of the invention in the static position;

FIG. 10—a side view of the device in FIG. 9 with the approach of SM;

FIG. 11—a cross-section A-A of the device in FIG. 10;

FIG. 12—a longitudinal section of the third device modification according to the second embodiment of the invention in the static position;

FIG. 13—a longitudinal section of the device in FIG. 12 with the approach of SM;

FIG. 14—a side view of the first device modification according to the third embodiment of the invention in the static position;

FIG. 15—a side view in FIG. 14 with the approach of SM;

FIG. 16—a cross-section B-B of the device in FIG. 15;

FIG. 17—a side view of the second device modification according to the third embodiment of the invention in the static position;

FIG. 18—a side view in FIG. 17 with the approach of SM in disengaged position;

FIG. 19—a side view in FIG. 17 with the approach of SM in engaged position.

### DETAILED DESCRIPTION OF THE INVENTION

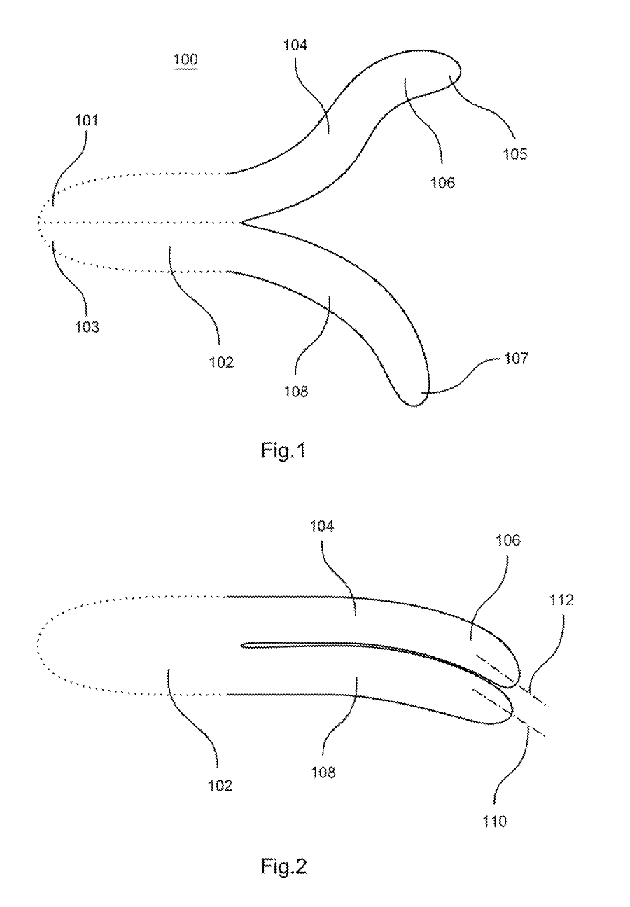

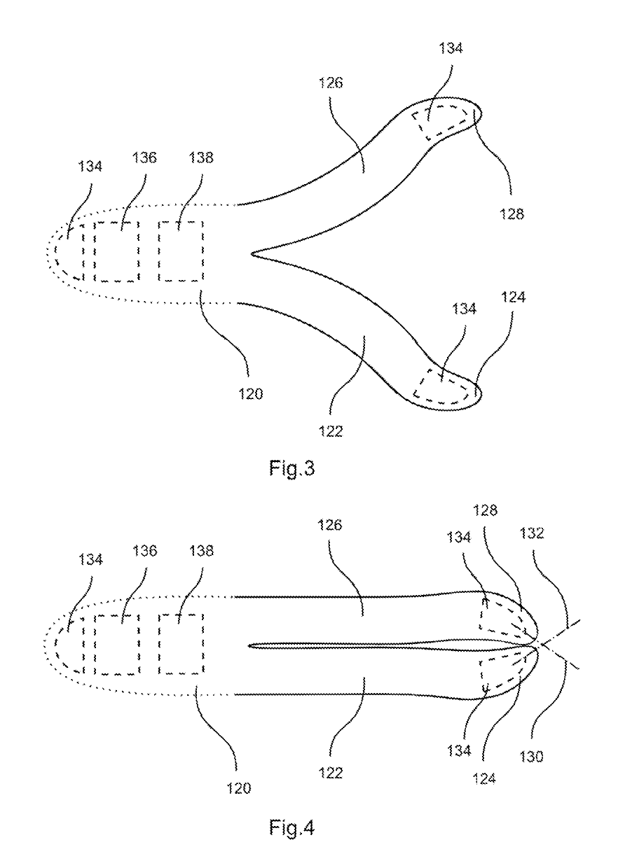

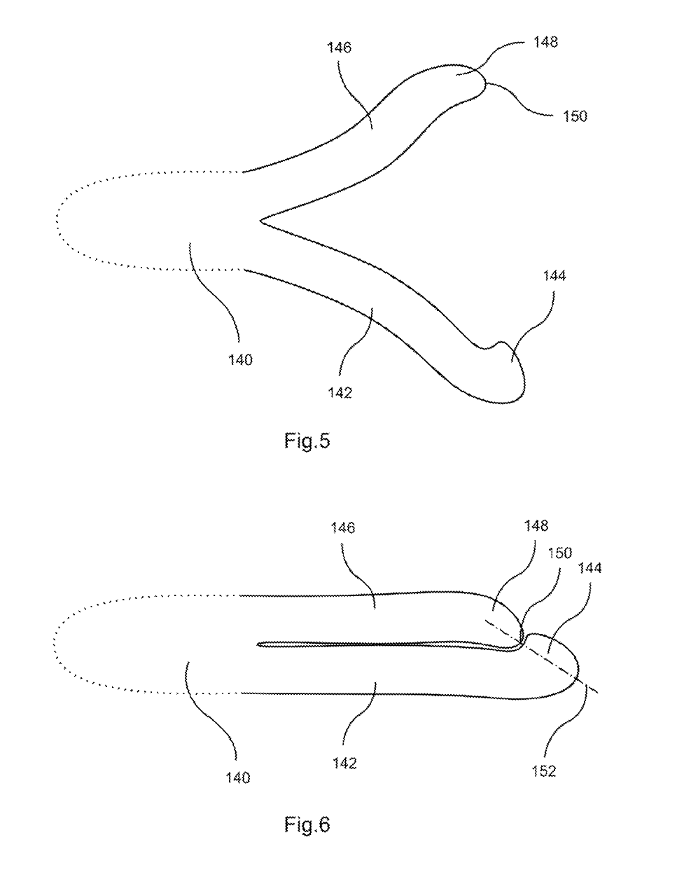

Implementation of the first embodiment of the invention. FIG. 1 shows the first modification of the device 102 with the first stimulating member (hereinafter SM) 104 made from resiliently deformable material with a bend 106 towards the second SM 108 made from the same material and connected to the first SM. To insertion of the device both SMs are approached, keeping them at a distance of several centimeters from the end tops, as shown in FIG. 2 so that the directions of the ends indicated by dash-dotted lines 110 and 112 are substantly parallel. FIG. 3 shows the second device modification 120 made from resiliently deformable material with the first SM 122 provided with a bend 124 towards the second SM 126 provided with a bend 128 towards the first SM. When approaching the both SMs to form a shape suitable for insertion, the direction of their ends, indicated by dash-dotted lines 130 and 132 intersect, as shown in FIG. 4. The device also comprises three vibratory devices 134 located in the device and SMs free ends, control system 136 and power supply unit 138, shown with dashed line. FIG. 5 shows a third modification of the device 140 made from resiliently deformable material, with the first SM 142 formed with an elongation 144 with relative to the second SM 146, which is formed with a bend 148 toward the first SM. When approaching the both SMs to form a shape suitable for insertion, the vertex 150 of the second SM is covered by the first SM, and direction of the free end indicated by dash-dotted line 152 intersects the first SM, as shown in FIG. 6.

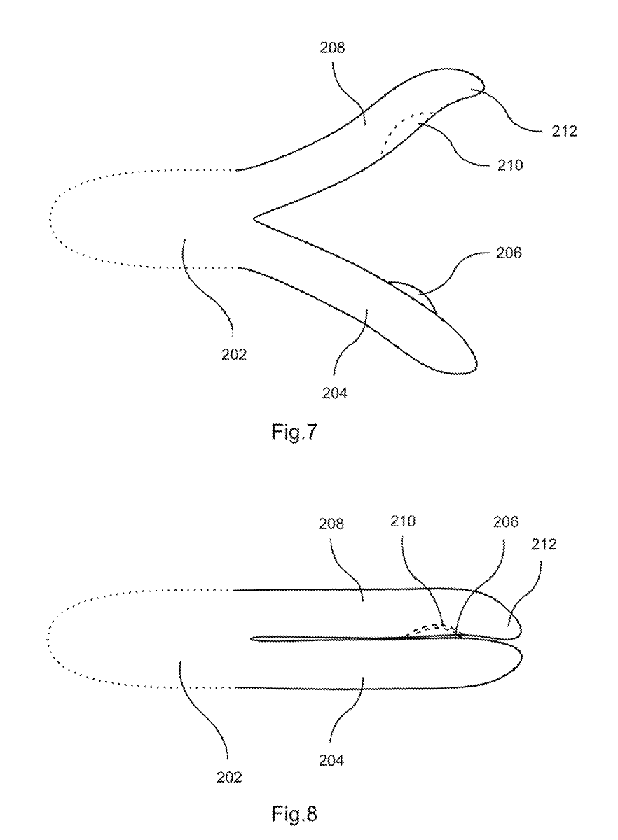

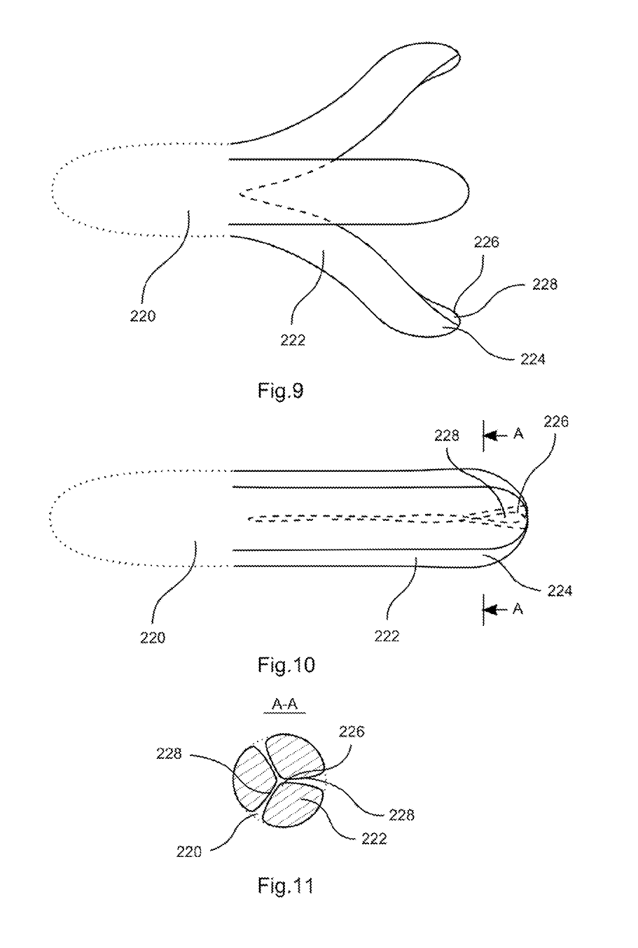

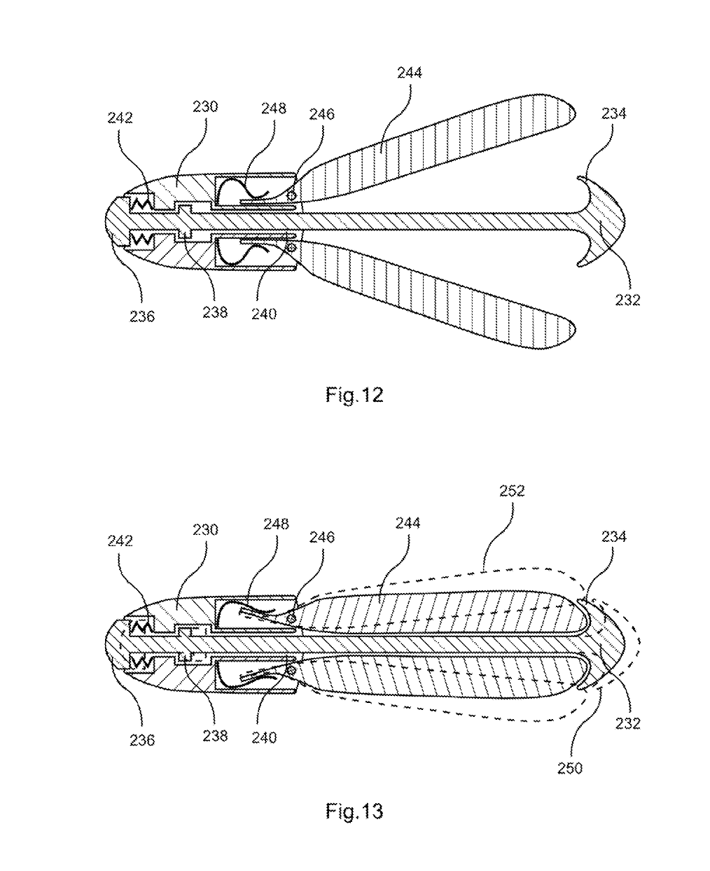

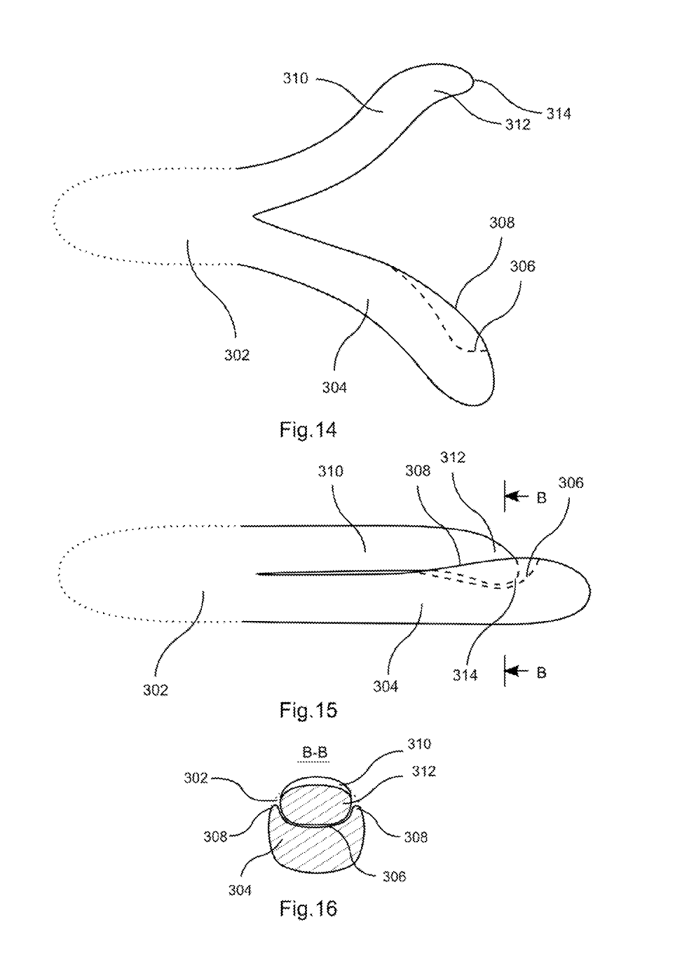

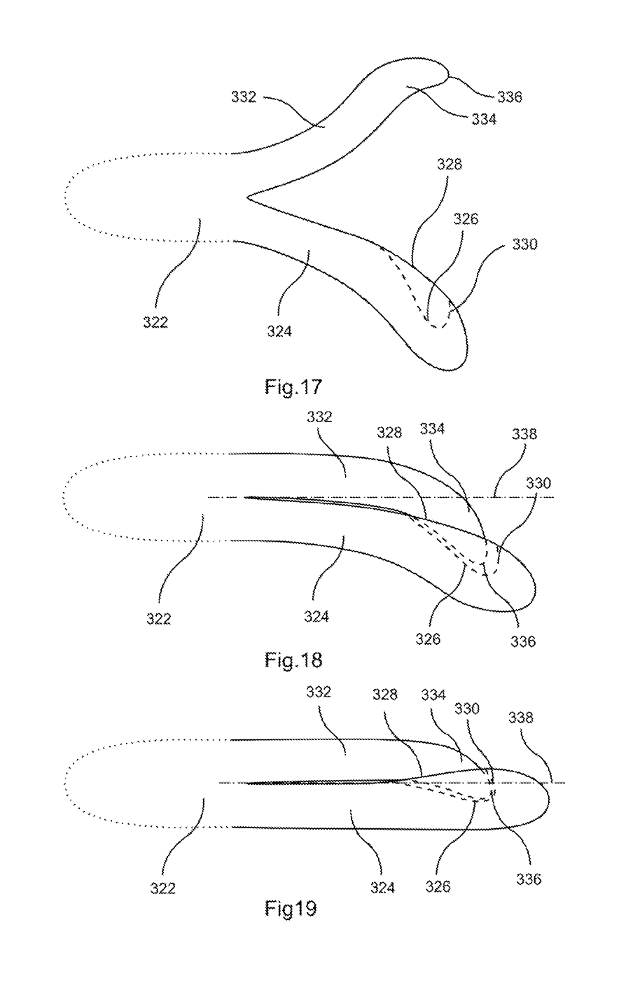

Implementation of the second embodiment of the invention. FIG. 7 shows the first modification of the device 202 with the first SM 204 made from resiliently deformable material with a protrusion 206 facing towards the second SM 208 with has a groove 210 of the matching form of the protrusion and is formed with a bend 212 towards the first SM. To insertion the device both SMs are approached, as shown in FIG. 8, wherein protrusion 206 is placed in groove 210 and restrict lateral displacement of the approach of SMs. FIG. 9 shows the second modification of the device 220 with three SMs made from resiliently deformable material, the first SM 222 of which is provided with a bend 224 towards the second and the third SMs made similarly to the first SM, and a protrusion 226 that forms adjacent surfaces 228 on both sides. To insertion of the device all these SMs are approached, as shown in FIG. 10, and the protrusion 226 is placed in the groove formed by the adjacent surfaces of the protrusions 228 of the second and third SMs, as shown in cross-section A-A in FIG. 11, what restricts lateral displacement of approximate SMs. FIG. 12 shows a longitudinal section of the third device modification 230 made from rigid material with the central SE 232, with paired hook-latch elements 234 on the front end, driven protrusion 236 on the rear end and a restricting protrusion 238 in the middle part. The central SM 232 is located in the device shaft 240 with possibility of elastic longitudinal motion, and for that purpose it is spring-loaded with elastic element 242. In addition, the device 230 comprises paired SMs 244, made from rigid material with possibility of elastic approximation with the central SE and for that purpose they are placed on axis 246 and spring-loaded with elastic element 248. FIG. 13 shows longitudinal displacement of the central SM 232 with a dotted line 250, pressing the driven protrusion 236, whereas the locking element 234 is moved and allows the paired SMs to approach the central SM,

1-15. (canceled)

16. A sexual stimulation device, comprising a first and at least a second elongated stimulating members connected to each other with their first ends, free second ends of the stimulating members being adapted to be resiliently brought together to thus essentially form a dildo, wherein at least the first stimulating member is made with a bend towards the at least second stimulating member.

17. The device of claim 16, wherein the at least second stimulating member is made with a bend toward the first stimulating member.

18. The device of claim 16, wherein the first stimulating member is made longer than said at least second stimulating member, and the free end of the first stimulating member is adapted to cover the vertex of the free end of said at least second stimulating member when they are brought together

19. The device of claim 16, wherein the free ends of the stimulating members are made with restriction of a lateral displacement thereof relative to each other when brought together.

20. The device of claim 19, wherein the first stimulating member is provided with at least one protrusion on a surface facing said at least second stimulating member, which is provided with at least one mating recession.

21. The device of claim 16, comprising three stimulating members, each of the three stimulating members being provided with a protrusion on a surface thereof facing the other stimulating members, areas of each two stimulating members adjacent to the protrusion and to each other forming jointly a space for receiving the protrusion of the third stimulating member when the stimulating members are brought together, to thereby restrict a lateral displacement of the stimulating members relative to each other.

22. The device of claim 16, wherein it is made of silicone rubber and is provided with at least one vibration unit, a control unit, and a power supply unit.

23. A device for sexual stimulation, comprising a first and a second elongated stimulating members connected to each other with their first ends, free ends of the stimulating members being adapted to be resiliently brought together to thus essentially form a dildo, wherein the first stimulating member is shorter than the second stimulating member, and the second stimulating member is formed with a recession to receive the free end of the first stimulating member, when the elements are brought together.

24. The device of claim 23, wherein said recession is adapted to cover the vertex of the free end of the first stimulating member, when the elements are brought together.

25. The device of claim 23, wherein said recession is adapted to restrict lateral displacement of stimulating members relative each other when they are brought together.

26. The device of claim 24, wherein the stimulating elements are adapted to be longitudinally displaced relative each other, the second stimulating member is made with a reverse bend to engage the free end of the first stimulating member when the stimulating elements are brought together, the stimulating elements being disengaged from each other when longitudinally displaced relative each other.

27. The device of claim 23, wherein at least one stimulating member is made with a bend towards the other stimulating member.

28. The device of claim 23, wherein it is made of silicone rubber and is provided with at least one vibration unit, a control unit, and a power supply unit.
